(19) United States
(12) Patent Application Publication
(10) Pub. No.: US 2025/0115150 A1
(43) Pub. Date: Apr. 10, 2025

(54) SELECTIVE POWER TRANSFER INTERFACE SYSTEM AND METHOD FOR ELECTRIC VEHICLE CHARGING

(71) Applicant: Tru-Lock Technologies LLC, Charleston, SC (US)

(72) Inventors: Ashley Wilson Truluck, Charleston, SC (US); Kathryn Truluck Krogh, Charleston, SC (US)

(21) Appl. No.: 18/378,557

(22) Filed: Oct. 10, 2023

(51) Int. Cl. B60L 53/65; B60L 53/66; B60L 53/68

(52) U.S. Cl. CPC B60L 53/65; B60L 53/66; B60L 53/68; B60L 2240/70

(57) ABSTRACT

Certain embodiments of the present disclosure enable a charging authentication method and system configured to authenticate a power transfer interface between a power source and at least one device to facilitate a wired and/or wireless charging subscription associated with a user, user device, server device, vehicle, mobility device, and/or charging source, a flow of power and/or a stream of data. The charging subscription may enable a device to receive a charge or power from another device and/or power source if the device or a user thereof has a valid subscription associated with the other device and/or power source. A charging device or power source may provide a charge or power to a device if the device and/or user has a validated subscription associated with the charging device or power source and may not provide the charge or power to the device if the subscription is not validated.

### FIELD

The present disclosure relates to the field of power transfer interfaces for electric vehicles; in particular, a system and method for verifying and enabling a subscription-based power transfer interface between an electric vehicle and a charging station.

### BACKGROUND

A charging station, also known as a charge point or electric vehicle supply equipment (EVSE), is a power supply device that supplies electrical power for recharging plug-in electric vehicles (including battery electric vehicles, electric trucks, electric buses, neighborhood electric vehicles and plug-in hybrid vehicles). There are two main types: AC charging stations and DC charging stations. Electric vehicle batteries can only be charged by direct current (DC) electricity, while most mains electricity is delivered from the power grid as alternating current (AC). For this reason, most electric vehicles have a built-in AC-to-DC converter commonly known as the “onboard charger”. At an AC charging station, AC power from the grid is supplied to this onboard charger, which converts it into DC power to then recharge the battery. DC chargers facilitate higher power charging (which requires much larger AC-to-DC converters) by building the converter into the charging station instead of the vehicle to avoid size and weight restrictions. The station then supplies DC power to the vehicle directly, bypassing the onboard converter. Most modern electric car models can accept both AC and DC power.

Charging stations provide connectors that conform to a variety of international standards DC charging stations are commonly equipped with multiple connectors to be able to charge a wide variety of vehicles that utilize competing standards. Public charging stations are typically found street-side or at retail shopping centers, government facilities, and other parking areas. Private charging stations are typically found at residences, workplaces, and hotels. Both public and private charging stations often have associated fees to be paid by the user for the use of the charging station. Certain challenges exist with respect to facilitating authorized use and associated payments for EV charging stations.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Certain aspects of the present disclosure provide for an electric vehicle charging method comprising one or more steps or operations for establishing a power transfer interface between a power source and an electric vehicle; receiving, via the power transfer interface, a first flow of power from the power source at the electric vehicle; processing, with an on-board processing unit of the electric vehicle, the first flow of power to determine a first set of power information data from the first flow of power; processing, with the on-board processing unit of the electric vehicle, the first set of power information data to determine whether the first set of power information data is associated with an authorized power source for at least one charging subscription service for the electric vehicle; and receiving, with an on-board charger of the electric vehicle, the first flow of power in response to determining that the first set of power information data is associated with the authorized power source for the at least one charging subscription service for the electric vehicle, wherein the on-board charger of the electric vehicle is configured to charge a battery of the electric vehicle via the first flow of power.

In accordance with certain aspects of the present disclosure, the electric vehicle charging method may further comprise one or more steps or operations for rejecting (e.g., with the on-board charger of the electric vehicle) the first flow of power in response to determining that the first set of power information data is not associated with the authorized power source for the at least one charging subscription service for the electric vehicle. In certain embodiments, processing the first set of power information data may comprise one or more steps or operations for comparing the first set of power information data to at least one second set of power information data, wherein the second set of power information data is stored in an on-board memory device of the electric vehicle. In certain embodiments, the power transfer interface may comprise a wireless power transfer interface. The electric vehicle charging method may further comprise one or more steps or operations for communicating (e.g., with an on-board communications module of the electric vehicle) subscription identification data for the at least one charging subscription service for the electric vehicle to at least one remote server. In certain embodiments, the at least one remote server may be configured to process the subscription identification data to determine a subscription status for the electric vehicle or at least one user of the electric vehicle. The electric vehicle charging method may further comprise one or more steps or operations for communicating (e.g., with the remote server via the network communications interface) the subscription status for the electric vehicle or at least one user of the electric vehicle to the on-board communications module of the electric vehicle.

Further aspects of the present disclosure provide for an electric vehicle charging method comprising one or more steps or operations for receiving, via a communications module of an electric vehicle, a first wireless signal from a first electric vehicle charging station, wherein the first electric vehicle charging station is associated with a charging subscription service; processing, via an on-board processor of the electric vehicle, the first wireless signal to determine a first set of data associated with the first electric vehicle charging station, wherein the first set of data is configured to identify one or more attributes of the first electric vehicle charging station; processing, via the on-board processor of the electric vehicle, the first set of data associated with the first electric vehicle charging station to determine a subscription status for the charging subscription service between the first electric vehicle charging station and the electric vehicle; initiating, via a wireless power transfer interface, a first flow of power between the first electric vehicle charging station and the electric vehicle in response to determining a valid subscription status for the charging subscription service between the first electric vehicle charging station and the electric vehicle; and receiving, with an on-board charger of the electric vehicle, the first flow of power from the first electric vehicle charging station, wherein the on-board charger of the electric vehicle is configured to charge a battery of the electric vehicle via the first flow of power.

In accordance with certain aspects of the present disclosure, the electric vehicle charging method may further comprise one or more steps or operations for determining (e.g., via the on-board processor of the electric vehicle) a first distance between the first electric vehicle charging station and the electric vehicle, wherein the first distance comprises a range of the wireless power transfer interface between the first electric vehicle charging station and the electric vehicle. The electric vehicle charging method may further comprise one or more steps or operations for discontinuing the first flow of power between the first electric vehicle charging station and the electric vehicle wherein the first distance is greater than a specified threshold. The electric vehicle charging method may further comprise one or more steps or operations for receiving (e.g., via the communications module of the electric vehicle) a second wireless signal from a second electric vehicle charging station, wherein the second electric vehicle charging station is located at a different location from the first electric vehicle charging station. The electric vehicle charging method may further comprise one or more steps or operations for processing (e.g., via the on-board processor of the electric vehicle) the second wireless signal to determine a second distance between the second electric vehicle charging station and the electric vehicle. The electric vehicle charging method may further comprise one or more steps or operations for establishing a second wireless power transfer interface between the second electric vehicle charging station and the electric vehicle. The electric vehicle charging method may further comprise one or more steps or operations for initiating, (e.g., via the second wireless power transfer interface) a second flow of power between the second electric vehicle charging station and the electric vehicle.

Still further aspects of the present disclosure provide for a method comprising one or more steps or operations for receiving, by a user device, a power flow from a charge source associated with a subscription service; obtaining, by the user device, a first power information from the power flow; determining, by the user device, whether the first power information matches a second power information stored in a memory device of the user device, wherein the second power information is associated with the subscription service, wherein the second power information was stored in the memory device of the user device prior to receiving the power flow; and receiving, at a charging interface of the user device, a first power transfer from the power flow in response to determining that the first power information matches the second power information.

In accordance with certain aspects of the present disclosure, the electric vehicle charging method may further comprise one or more steps or operations for rejecting, at the charging interface of the user device, the first power transfer from the power flow in response to determining that the first power information does not match the second power information. In certain embodiments, the user device comprises an electric vehicle. In certain embodiments, the electric vehicle charging method may further comprise one or more steps or operations for establishing a power transfer interface between the charge source and the user device. In certain embodiments, the power transfer interface comprises establishing an interface between a charging cable between the charge source and the user device. In certain embodiments, the power transfer interface may comprise a wireless power transfer interface.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. The above and other objects, features and advantages of the present disclosure will be more apparent from the following detailed description taken in conjunction with the accompanying drawings, in which:

FIG. 1A is an architecture diagram of a subscription-based electric vehicle charging system, in accordance with certain aspects of the present disclosure;

FIG. 1B is an architecture diagram of a subscription-based electric vehicle charging system, in accordance with certain aspects of the present disclosure;

FIG. 1C is an architecture diagram of a subscription-based electric vehicle charging system, in accordance with certain aspects of the present disclosure;

FIG. 2 is a functional block diagram of a subscription-based electric vehicle charging system and method;

FIG. 3 is a functional block diagram of a subscription-based electric vehicle charging system and method;

FIG. 4 is a functional block diagram of a subscription-based electric vehicle charging system and method;

FIG. 5 is a functional block diagram of a subscription-based electric vehicle charging system and method;

FIG. 6 is a functional block diagram of a subscription-based electric vehicle charging system and method;

FIG. 7 is a process flow diagram of a subscription-based electric vehicle charging method, in accordance with certain aspects of the present disclosure;

FIG. 8 is a process flow diagram of a subscription-based electric vehicle charging method, in accordance with certain aspects of the present disclosure;

FIG. 9 is a process flow diagram of a subscription-based electric vehicle charging method, in accordance with certain aspects of the present disclosure; and

FIG. 10 is a diagram of an exemplary computing system through which one or more aspects of the present disclosure may be implemented.

### DETAILED DESCRIPTION

It should be appreciated that all combinations of the concepts discussed in greater detail below (provided such concepts are not mutually inconsistent) are contemplated as being part of the inventive subject matter disclosed herein. It also should be appreciated that terminology explicitly employed herein that also may appear in any disclosure incorporated by reference should be accorded a meaning most consistent with the particular concepts disclosed herein.

Following below are more detailed descriptions of various concepts related to, and embodiments of, inventive methods, devices and systems configured to provide for electric vehicle charging systems and electric vehicle supply equipment comprising wireless and wireless power and data interfaces.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The present disclosure should in no way be limited to the exemplary implementation and techniques illustrated in the drawings and described below.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein, “exemplary” means serving as an example or illustration and does not necessarily denote ideal or best.

As used herein, the term “includes” means includes but is not limited to, the term “including” means including but not limited to. The term “based on” means based at least in part on.

As used herein, the term “packet” refers to any formatted unit of data that may be sent and/or received by an electronic device.

As used herein, the term “payload” refers to any part of transmitted data that constitutes an intended message and/or identifying information.

As used herein, the term “interface” refers to any shared boundary across which two or more separate components of an electronic system may exchange information, power and/or communications signals. The exchange can be between software, computer hardware, peripheral devices, humans, and combinations thereof.

As used herein, the term “connector” refers to any components of an electronic system configured to establish an interface.

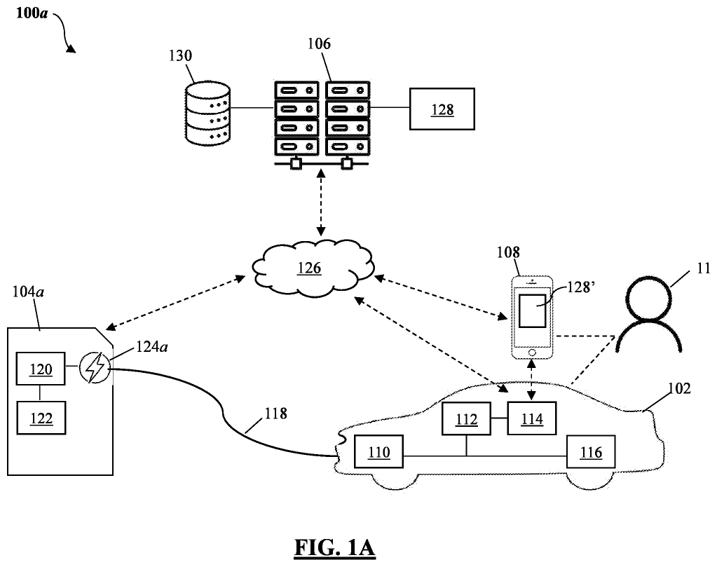

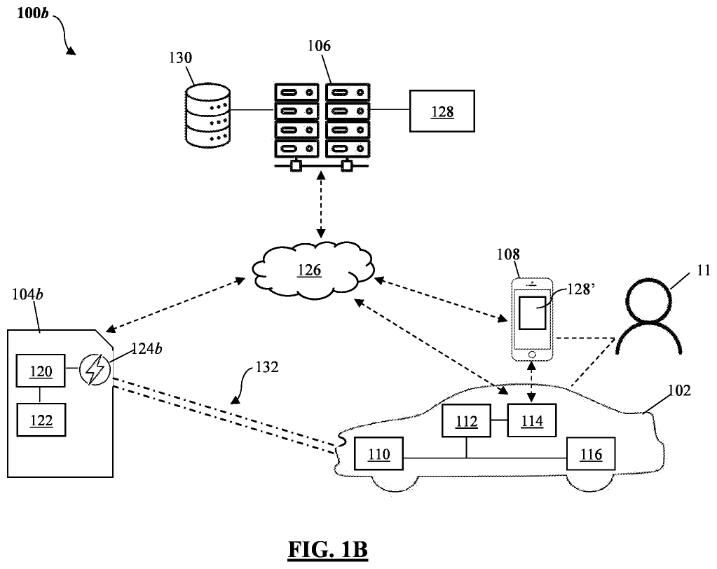

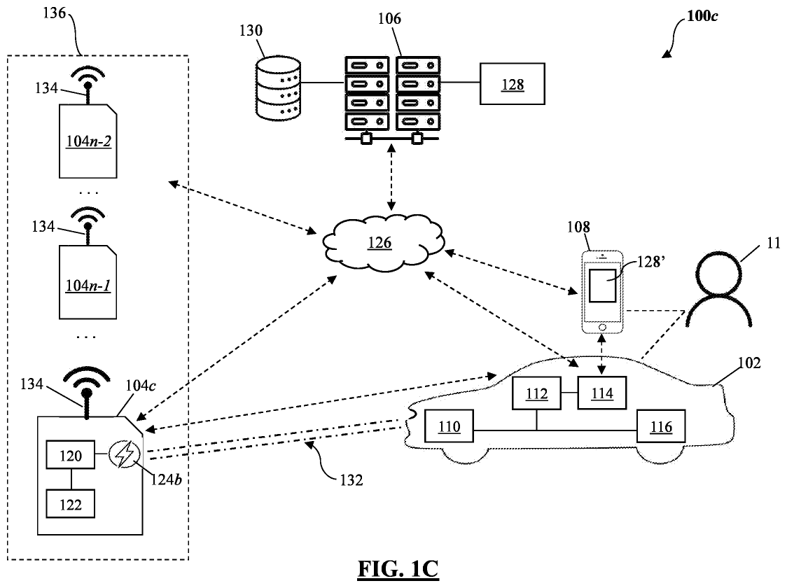

FIGS. 1A-10 are attached hereto and incorporated herein by reference. The following detailed description refers to the accompanying FIGS. 1A-10. The same reference numbers in different figures may identify the same or similar elements.

The systems, devices, methods, technologies and/or techniques described herein (collectively, the “systems and methods”) may enable wired and/or wireless selective charging and/or charge authentication of a user, a user device, a server device, a vehicle, a mobility device associated with the vehicle, and/or a charging source. Charge authentication may enable a device to authenticate another device and/or power source prior to authorizing or otherwise receiving a charge from the other device and/or power source in accordance with the non-limiting disclosure described below.

The systems and/or methods may enable wired and/or wireless charge subscription associated with the user, the user device, the server device, the vehicle, the mobility device, and/or the charging source, a flow of power (hereinafter, a “power flow”) and/or a stream of data (hereinafter, a “data stream”). The charge subscription may enable a device to receive a charge or power from another device and/or power source if the device or user thereof has a valid subscription associated with the other device and/or power source.

Additionally, or alternatively, a charging device or power source may provide a charge or power to a device if the device and/or user thereof has a validated subscription associated with the charging device or power source and may not provide the charge or power to the device if the subscription is not validated in accordance with the non-limiting disclosure described below.

The user device may include a computational and/or communication device associated with a user (e.g., a smart phone, a personal digital assistance (PDA), a laptop computer, a desktop computer, etc.). The user device may be capable of performing all or a portion of the methods, steps, operations and/or functions associated with the wired and/or wireless selective charging and/or charge authentication as described herein. The user device may be capable of performing the wired and/or wireless power subscription service associated with the user, the user device, the vehicle, the mobility device, the charging source, the server device, a power flow and/or a data stream.

The vehicle may be capable of performing transportation or mobility functions over ground, over water, under water, through the air, or through space. For example, the vehicle may correspond to a bicycle, an automobile (e.g., a car, truck, van, etc.), a motorcycle, a commercial vehicle (e.g., a bus, tractor trailer, etc.), a military and/or construction vehicle (e.g., an armored personnel carrier, a tank, a bulldozer, a backhoe, a dump truck, etc.), a marine vessel (e.g., a power boat, a sailboat, a yacht, a ferry boat, a ship, a submarine, etc.), an aircraft or space craft.

The mobility device may include a computational and/or communication device associated with the vehicle and/or user. The mobility device may be permanently installed or embedded, temporarily attached to and/or retrofitted, and/or otherwise portably carried inside, on a surface, and/or outside of the vehicle (on the roof, under the hood or chassis, within the interior or trunk, within an electrical or digital network or device, etc.). The mobility device may be electrically connected to the vehicle electrical system, device and/or network; vehicle central processing unit (CPU); vehicle digital circuit, device and/or network; and/or any sensor (e.g., radio antenna, RF antenna, electrooptical sensor, etc.) associated with the vehicle. In one non-limiting example, the mobility device may be a self-contained and/or portable mobility device (e.g., with one or more of its own power source (battery), power supply, power cable, sensor (RF, EOIR, etc.), CPU, etc.) that enables the mobility device to be carried, by the operator, to the vehicle and transported with the vehicle and/or removed from the vehicle after the operator exits the vehicle. In another non-limiting example, the portable mobility device may correspond to a user device. The mobility device (including the portable mobility device) may be capable of performing all or a portion of the methods, steps and/or functions associated with wired and/or wireless selective charging and/or charge authentication, and/or the wired and/or wireless power subscription services associated with the user, the user device, the vehicle, the mobility device, the charging source, the server device, a power flow and/or a data stream.

The charging device may include any device that receives power and/or a power flow from a power source (e.g., an electrical generator, a solar panel, a windmill, a battery, an inverter, and the like) and transmits such power and/or power flow, wired or wirelessly, to the user device and/or mobility device. In one non-limiting example, the charging device may condition the power by amplification, attenuation, rectification, AC to DC conversion, DC to AC conversion, inversion, and the like.

The devices described above may be connected via one or more wired and/or wireless network. In one example, the network my include two or more charge devices that may be distributed over a geographic area, such as a distributed charging network, a mesh network, etc.

The power, power flow, and/or data stream may be transmitted and/or otherwise propagated via a “wired” medium (e.g., a conductive wire, conductive cable, a coaxial cable, an Ethernet cable, a waveguide, an optical fiber, a fiber optic cable, etc.), a smart cord (e.g., “Guardian cord”) and/or wirelessly (e.g., over the air or atmosphere (OTA), via a fluid (liquid, gas, plasma, etc.), via a slurry, via a vacuum, within Line of Site (LOS), beyond Line Of Sight (BLOS), etc.) and through any portion of the electromagnetic spectrum in the form of, for example, a digital signal, an analog signal, an electrical signal (e.g., alternating current (AC), direct current (DC), etc.), an electromagnetic signal (e.g., HF, VHF, UHF, L-band, S-band, C-band, X-band, Ku-band, Ka-band, millimeter wave, X-ray Gamma-ray, etc.) an electro-optical signal (infrared, visual, ultraviolet, etc.), etc.

The power flow may include power (e.g., from a power source and/or charging device) associated with information that enables the power and/or power flow to be identified (hereinafter, “power information”). The power information may, for example, include unique, one-of-a-kind digital and/or analog information (e.g., associated with one or more particular frequencies, frequency bands, bits, bytes, symbols, phases, polarizations, waveforms, modulations techniques, pulses, duty cycles, etc.) that enable the power and/or power flow to be identified and/or distinguished from other power and/or power flows with different power information or no power information.

Additionally, or alternatively, the power information may include information that describes characteristics of the power and/or power flow, such as, for example, the type of power (e.g., DC, single-phase AC, 3-phase AC, Infrared (IR), microwave, etc.), a power level (e.g., watts, volts, etc.), power frequency (e.g., 60 Hz, 1 KHz, 1 MHz, 50 MHz, etc.), a wavelength (e.g., 7-11 μm, etc.), etc.

Additionally, or alternatively, the power information may include information that enables the power and/or power flow to be encoded, encrypted, decoded, decrypted, compressed, decompressed, etc. In one non-limiting example, the power information may include a key (e.g., a public key, a private key, a checksum, a hash, etc.) that enables one or more processes to be performed on the power and/or power flow to encode, encrypt, decode, decrypt, compress, decompress, etc.

Additionally, or alternatively, the power flow may include power associated with information that enables a charging source and/or charging device, from which the power is transmitted and/or received, to be identified (hereinafter, “source information”). The source information may, for example, identify the power source (e.g., based on a serial number; a type, a model, and/or series of the power source, etc.) and/or a power utility associated with the power source (e.g., the utility name, a unique utility identifier, a utility generating location, a utility generation plant name or identifier, etc.).

In one non-limiting embodiment, a user device, mobility device, server device, etc. may be programmed by a user, a vendor, a manufacturer, etc. (e.g., using an application, mobile application, or other logic stored in the user device) to accept a charge from a first power source and/or first power flow if first power information, obtained by the first power flow, matches power information programmed into a memory associated with the user device, mobility device, server device, etc. In another example, the user device, mobility device, or server device may not accept a charge from a second power source and/or second power flow if second power information, obtained from the second power flow, does not match any power information programmed into the memory. In these examples, an electric vehicle (for example) may be equipped with a mobility device that accepts or rejects a charge from a power flow in a manner similar to that described above.

In another non-limiting embodiment, an electric vehicle, associated with a mobility device, may receive a power flow from a charging device (via a wired cable, wirelessly via an induction charging device) or from one or more charging devices associated with a network (e.g., a power network comprised of two or more charging device—such as, for example, a mesh network) and may authenticate the power flow and/or charging devices in a manner described above in the immediately preceding paragraph. In one non-limiting embodiment, as the electric vehicle moves or otherwise changes location within proximity of a distributed network of charging devices (e.g., a mesh network or some other distributed network), the mobility device may charge authenticate one or more charging device, associated with a network, as the vehicle moves within the signal coverage of the charging devices within the network.

The mobility device may obtain from the power flow subscription information and may compare the subscription information to first subscription information (e.g., stored in a memory associated with the mobility device, etc.). The mobility device may send, to the charging device, user subscription information (e.g., a username, a password, biometric information, a unique identifier such as a PIN, unique subscription identifier), information associated with the vehicle (e.g., a VIN number or some other unique vehicle identifier), and/or information associated with the mobility device (e.g., a serial number, a SIM number, an electronic serial number, a MID, etc.). The charging device may receive the user subscription information and, in one example, may charge the vehicle when the user information matches subscription information stored in a memory associated with the charging device.

In another non-limiting example, the charging device may receive the user subscription information and may communicate with a server device associated with a power utility from which the power and/or power flow originates. The server device may compare the received user subscription information to stored user subscription information (e.g., stored in a memory associated with the server device). If the received user subscription information matches the stored user subscription information, the server device may send a first instruction to the charging device to charge the vehicle (e.g., charge a battery associated with the vehicle and/or mobility device). In another example, if the received user subscription information does not match the stored user subscription information, the server device may send a second instruction to the charging device that precludes charging the vehicle.

Additionally, or alternatively, the server device and/or charging device may identify an account associated with the first user subscription information. The server device may determine that the account is current and/or otherwise in good standing and may transmit, to the charging device, a first instruction to charge the vehicle. In the event that the server device and/or charging device determines that the account is not current, past due, and/or otherwise not in good standing, the server device may transmit, to the charging device, a second instruction to preclude charging the vehicle.

Referring now to FIG. 1A, an architecture diagram of a subscription-based electric vehicle charging system 100a is shown. In accordance with certain aspects of the present disclosure, system 100a is configured to enable a subscription-based power transfer interface between an electric vehicle 102 and a charging station 104a. Electric vehicle 102 may commonly comprise a fully electric or hybrid electric automobile but may also include a variety of other fully or partially electric vehicles and personal conveyances, such as bicycles, motorcycles, trucks, scooters, boats, trains, planes, and the like. In accordance with certain aspects of the present disclosure, electric vehicle 102 may comprise an on-board charger 110, an on-board controller 112, a communications module 114, and a battery bank 116. On-board charger 110 may be operably engaged with battery bank 116 to deliver a DC power current thereto, in order to charge one or more batteries of battery bank 116. In accordance with certain embodiments, communications module 114 may comprise a wireless transceiver configured to send and receive one or more wireless communications (e.g., cellular, BLUETOOTH, radio frequency, etc.). Communications module 114 may be communicably engaged with on-board controller 112 to send and receive one or more data packets to and from on-board controller 112. In certain embodiments, communications module 114 may be integrally installed in electric vehicle 102; and in other embodiments, communications module 114 may comprise a removable hardware device, such as a tablet computer, a wireless beacon, a cellular gateway device, a smart phone, and the like. In accordance with certain embodiments, system 100a may comprise an end-user device 108 associated with an end user 11. End-user device 108 may comprise a smart phone or other personal computing device or mobile electronic device. End user 11 may comprise a driver of electric vehicle 102. End-user device 108 may be communicably engaged with communications module 114 and/or on-board controller 112 via a wireless data transfer interface (e.g., BLUETOOTH) or a wireline data bus (e.g., USB cable). Charging station 104a may comprise a power delivery interface 124a, a controller 120 and, optionally, a transceiver 122. Power delivery interface 124a may be configured to transfer power from a power source to a power transfer interface; for example, a charging cable 118. Charging cable 118 may be configured to establish a selective interface between electric vehicle 102 and charging station 104a to enable a flow of power between power delivery interface 124a and on-board charger 110. Controller 120 may comprise a microprocessor and one or more transitory and non-transitory memory devices configured to facilitate one or more operations of charging station 104a. Transceiver 122 may be communicably engaged with controller 120 to send and receive one or more data signals to and from charging station 104a and one or more networked devices (e.g., electric vehicle 102).

In accordance with certain aspects of the present disclosure, system 100a may further comprise an application server 106 and an application database 130. Application server 106 may comprise a charging application 128 configured to facilitate one or more functions and operations of a subscription-based charging service. In certain embodiments, user device 108 may comprise an end-user instance 128′ of charging application 128. In accordance with certain aspects of the present disclosure, one or more of application server 106, user device 108, electric vehicle 102 and charging station 104a may be communicably engaged via a communications network 126 to facilitate one or more functions and/or operations of the subscription-based charging service.

In accordance with certain exemplary use cases, end user 11 may establish a power transfer interface between electric vehicle 102 and charging station 104a by connecting charging cable 118 between electric vehicle 102 and charging station 104a. In accordance with certain embodiments, power delivery interface 124a may be configured to deliver a power flow to on-board charger 110 in response to end user 11 establishing the power transfer interface between electric vehicle 102 and charging station 104a. On-board charger 110 may receive the power flow via charging cable 118 and communicate one or more power information signal to on-board controller 112. Controller 112 may be configured to process the power information data to determine one or more power information data. The power information data may include, for example, unique, one-of-a-kind digital and/or analog information (e.g., associated with one or more particular frequencies, frequency bands, bits, bytes, symbols, phases, polarizations, waveforms, modulations techniques, pulses, duty cycles, etc.) that enable the power flow to be identified and/or distinguished from other power flows with different power information or no power information. In certain embodiments, controller 112 may communicate the power information data to end user device 108 via communications module 114. Controller 112 may be configured to process the power information data to determine whether one or more attributes of the power information data match one or more power information attributes stored in memory of controller 112 (e.g., prior to establishing the power transfer interface between charging station 104a and electric vehicle 102). In certain embodiments, user device 108 may process the power information data according to one or more operations of end-user instance 128′ of charging application 128 to determine whether one or more attributes of the power information data match one or more power information attributes stored in memory. In accordance with certain aspects of the present disclosure, end-user instance 128′ may comprise one or more steps or operations for verifying a valid subscription for a charging subscription service for charging station 104a based on the power information data. In certain embodiments, end-user instance 128′ may comprise one or more steps or operations for making a request to application server 106 to verify a subscription status for end user 11 and/or electric vehicle 102 based on the power information data. In certain embodiments, upon verifying the subscription status for end user 11 and/or electric vehicle 102, end-user instance 128′ may execute one or more functions or operations for rendering a confirmation at a graphical user interface of end-user instance 128′ and/or communicating at least one confirmation signal to on-board controller 112 (e.g., via communications module 114). On-board controller 112 may process the confirmation signal to confirm the subscription status for end user 11 and/or electric vehicle 102. In certain embodiments, on-board controller 112 may confirm the subscription status for end user 11 and/or electric vehicle 102 without any communication to/from user device 108 via one or more steps or operations for comparing the power information data (e.g., a first power information data) to power information data stored in local memory (e.g., a second power information data). In other embodiments, on-board controller 112 may send/receive one or more communications to/from server 106 via communications module 114 to confirm the subscription status for end user 11 and/or electric vehicle 102. In accordance with certain aspects of the present disclosure, upon successfully confirming the subscription status for end user 11 and/or electric vehicle 102, controller 112 may command one or more operations of on-board charger 110 to deliver power from the power flow to charge battery bank 116. Alternatively, if the subscription status for end user 11 and/or electric vehicle 102 is not successfully confirmed (i.e., the subscription is invalid or non-existent), controller 112 may command one or more operations of on-board charger 110 to block a transfer of power from the power flow to battery bank 116.

Referring now to FIG. 1B (with reference to FIG. 1A), an architecture diagram of a subscription-based electric vehicle charging system 100b is shown. In accordance with certain aspects of the present disclosure, the components shown in system 100b sharing the same reference numbers of system 100a are functionally and structurally the same as those shown and described in FIG. 1A. For the sake of brevity, a detailed description of identical components may not be repeated below in light of the detailed description provided in FIG. 1A. In accordance with certain embodiments, system 100b comprises a charging station 104b. Charging station 104b comprises a wireless power delivery interface 124b configured to deliver a wireless power flow 132 to on-board charger 110. In said embodiments, wireless power delivery interface 124b comprises a power source resonator configured to generate a magnetic resonance output and on-board charger 110 comprises a power capture resonator configured to receive the magnetic resonance output to enable the transfer of wireless power flow 132.

In accordance with certain aspects of the present disclosure, system 100b may be configured to establish wireless power flow 132 between wireless power delivery interface 124b and on-board charger 110 in response to electric vehicle 102 being positioned within a specified distance of charging station 104b. In certain embodiments, wireless power flow 132 may be automatically initiated in response to electric vehicle 102 being positioned within a specified distance of charging station 104b. On-board charger 110 may receive one or more power information signal from wireless power flow 132 and communicate the one or more power information signal to on-board controller 112. Controller 112 may be configured to process the one or more power information signal to derive one or more power information data (e.g., as described in FIG. 1A). In certain embodiments, controller 112 may communicate the power information data to end user device 108 via communications module 114. Controller 112 may be configured to process the power information data to determine whether one or more attributes of the power information data match one or more power information attributes stored in memory of controller 112 (e.g., prior to establishing wireless power flow 132). In certain embodiments, user device 108 may process the power information data according to one or more operations of end-user instance 128′ of charging application 128 to determine whether one or more attributes of the power information data match one or more power information attributes stored in memory. In accordance with certain aspects of the present disclosure, end-user instance 128′ may comprise one or more steps or operations for verifying a valid subscription for a charging subscription service for charging station 104b based on the power information data. In certain embodiments, end-user instance 128′ may comprise one or more steps or operations for making a request to application server 106 to verify a subscription status for end user 11 and/or electric vehicle 102 based on the power information data. In certain embodiments, upon verifying the subscription status for end user 11 and/or electric vehicle 102, end-user instance 128′ may execute one or more functions or operations for rendering a confirmation at a graphical user interface of end-user instance 128′ and/or communicating at least one confirmation signal to on-board controller 112 (e.g., via communications module 114). On-board controller 112 may process the confirmation signal to confirm the subscription status for end user 11 and/or electric vehicle 102. In certain embodiments, on-board controller 112 may confirm the subscription status for end user 11 and/or electric vehicle 102 without any communication to/from user device 108 via one or more steps or operations for comparing the power information data (e.g., a first power information data) to power information data stored in local memory of on-board controller 112 (e.g., a second power information data). In other embodiments, on-board controller 112 may send/receive one or more communications to/from server 106 via communications module 114 to confirm the subscription status for end user 11 and/or electric vehicle 102. In accordance with certain aspects of the present disclosure, upon successfully confirming the subscription status for end user 11 and/or electric vehicle 102, controller 112 may command one or more operations of on-board charger 110 to deliver power from wireless power flow 132 to charge battery bank 116. Alternatively, if the subscription status for end user 11 and/or electric vehicle 102 is not successfully confirmed (i.e., the subscription is invalid or non-existent), controller 112 may command one or more operations of on-board charger 110 to block a transfer of power from wireless power flow 132 to battery bank 116.

Referring now to FIG. 1C (with reference to FIG. 1B), an architecture diagram of a subscription-based electric vehicle charging system 100c is shown. In accordance with certain aspects of the present disclosure, the components shown in system 100c sharing the same reference numbers of system 100a and system 100b are functionally and structurally the same as those shown and described in FIGS. 1A-1B. For the sake of brevity, a detailed description of said components may not be repeated below in light of the detailed description in FIGS. 1A-1B. In accordance with certain embodiments, system 100c comprises a charging station network 136. Charging station network 136 may comprises two or more charging stations 104c, 104n-1 and 104n-2. While FIG. 1C illustrates three charging stations, charging station network 136 may comprise as few as two charging stations up to a theoretically unlimited number of charging stations. In certain embodiments, charging stations 104c, 104n-1 and 104n-2 are communicably engaged via at least one network interface (for example, communications network 126) to comprise a mesh network. In accordance with certain aspects of the present disclosure, charging stations 104n-1 and 104n-2 are structurally and functionally equivalent to charging station 104c.

In accordance with certain embodiments, charging station 104c comprises an antenna 134 configured to generate one or more wireless signal transmission (e.g., radio signal) over a specified range. In certain embodiments, the specified range of the wireless signal transmission may coincide with a range of wireless power flow 132. In accordance with certain aspects of the present disclosure, electric vehicle 102 may receive the one or more wireless signal transmission from charging station 104c upon entering the signal range of charging station 104c (i.e., within a specified distance of charging station 104c). The one or more wireless signal transmission may comprise one or more data packets comprising power information data (e.g., as described in FIG. 1A) associated with charging station 104c. Controller 112 may be configured to process the wireless signal transmission to derive the power information data. In certain embodiments, controller 112 may communicate the power information data to end user device 108 via communications module 114. Controller 112 may be configured to process the power information data to determine whether one or more attributes of the power information data match one or more power information attributes stored in memory of controller 112 (e.g., prior to establishing wireless power flow 132). In certain embodiments, user device 108 may process the power information data according to one or more operations of end-user instance 128′ of charging application 128 to determine whether one or more attributes of the power information data match one or more power information attributes stored in memory. In accordance with certain aspects of the present disclosure, end-user instance 128′ may comprise one or more steps or operations for verifying a valid subscription for a charging subscription service for charging station 104a based on the power information data. In certain embodiments, end-user instance 128′ may comprise one or more steps or operations for making a request to application server 106 to verify a subscription status for end user 11 and/or electric vehicle 102 based on the power information data. In certain embodiments, upon verifying the subscription status for end user 11 and/or electric vehicle 102, end-user instance 128′ may execute one or more functions or operations for rendering a confirmation at a graphical user interface of end-user instance 128′ and/or communicating at least one confirmation signal to on-board controller 112 (e.g., via communications module 114). On-board controller 112 may process the confirmation signal to confirm the subscription status for end user 11 and/or electric vehicle 102. In certain embodiments, on-board controller 112 may confirm the subscription status for end user 11 and/or electric vehicle 102 without any communication to/from user device 108 via one or more steps or operations for comparing the power information data (e.g., a first power information data) to power information data stored in local memory of on-board controller 112 (e.g., a second power information data). In other embodiments, on-board controller 112 may send/receive one or more communications to/from server 106 via communications module 114 to confirm the subscription status for end user 11 and/or electric vehicle 102. In accordance with certain aspects of the present disclosure, upon successfully confirming the subscription status for end user 11 and/or electric vehicle 102, controller 120 may command one or more operations of charging station 104c to initiate wireless power flow 132, and controller 112 may command one or more operations of on-board charger 110 to deliver power from wireless power flow 132 to charge battery bank 116. Alternatively, if the subscription status for end user 11 and/or electric vehicle 102 is not successfully confirmed (i.e., the subscription is invalid or non-existent), charging station 104c may refrain from initiating wireless power flow 132.

In accordance with certain aspects of the present disclosure, system 100c may be configured to determine that electric vehicle 102 has moved to a location that it out of range of the wireless signal transmission from antenna 134. In said embodiments, charging station 104c may be configured to terminate wireless power flow 132. Electric vehicle 102 may be driven by end user 11 to a location that is in a wireless signal transmission range of an antenna of charging station 104n-1 or 104n-2. In said embodiments, electric vehicle 102 may receive a wireless signal transmission from charging station 104n-1 or 104n-2 comprising power information data. System 100c may execute the same steps or operations as described in association with charging station 104c to process the wireless signal transmission from charging station 104n-1 or 104n-2 to verify a subscription status of user 11 and/or electric vehicle 102. Upon successfully verifying the subscription, charging station 104n-1 or 104n-2 may establish a wireless power transfer interface with electric vehicle 102 in the same manner as described in association with charging station 104c.

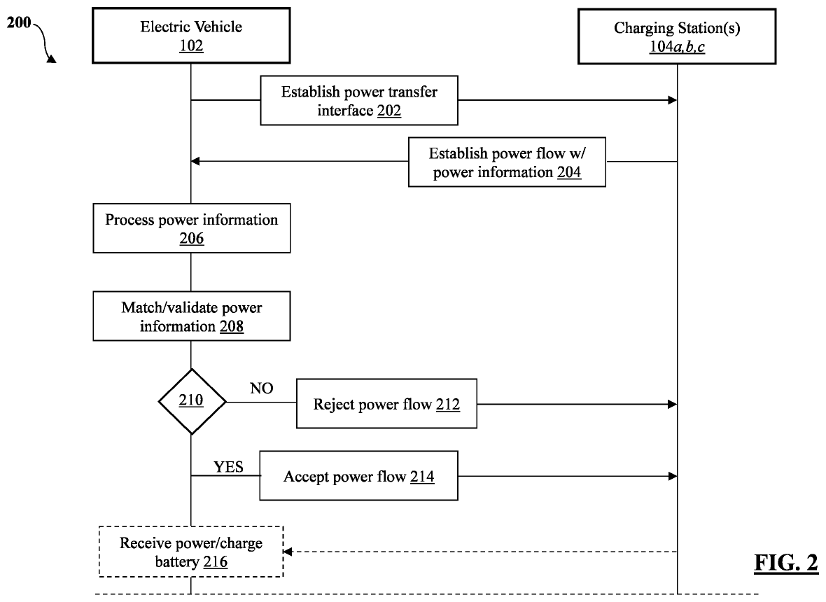

Referring now to FIG. 2, a functional block diagram of a process flow 200 for a subscription-based electric vehicle charging system and method is shown. In accordance with certain aspects of the present disclosure, process flow 200 comprises one or more routines and/or operations of system 100a of FIG. 1A and/or system 100b of FIG. 1B and/or system 100c of FIG. 1C. In accordance with certain aspects of the present disclosure, process flow 200 comprises one or more operations and/or data transfer protocols by and between electric vehicle 102 (e.g., as shown and described in FIGS. 1A-1C) and charging station(s) 104a,b,c (e.g., as shown and described in FIGS. 1A-1C). In accordance with certain aspects of the present disclosure, process flow 200 comprises one or more steps or operations for establishing a power transfer interface between electric vehicle 102 and charging station(s) 104a,b,c (Block 202). Process flow 200 may proceed by executing one or more steps or operations for establishing a power flow between charging station(s) 104a,b,c and electric vehicle 102 (Block 204). In accordance with certain embodiments, the power flow may comprise a first set of power information data. The power information data may include, for example, unique, one-of-a-kind digital and/or analog information (e.g., associated with one or more particular frequencies, frequency bands, bits, bytes, symbols, phases, polarizations, waveforms, modulations techniques, pulses, duty cycles, etc.) that enable the power flow to be identified and/or distinguished from other power flows with different power information or no power information. Process flow 200 may comprise one or more steps or operations (e.g., at electric vehicle 102) for processing the first set of power flow information data (Block 206) to match (or otherwise verify or validate) one or more attributes of the first set of power flow information data to a second set of power flow information data stored in local memory of electric vehicle 102 (or residing on a remote server communicably engaged with electric vehicle 102) (Block 208). In accordance with certain aspects of the present disclosure, process flow 200 may comprise one or more decision operations (Block 210) for verifying a subscription status for electric vehicle 102 based on the first set of power flow information data. In certain embodiments, Block 210 may comprise one or more steps or operations for determining whether the first set of power flow information data matches (or is otherwise compatible with or complementary to) the second set of power flow information data (e.g., according to an output of Block 208). If NO (i.e., the first set of power flow information data does not match or cannot be validated or authenticated based on the output of Block 208), then process flow 200 may proceed by executing one or more steps or operations (e.g., at electric vehicle 102) to reject the power flow from charging station(s) 104a,b,c (Block 212). If YES (i.e., the first set of power flow information data matches or is otherwise validated or authenticated based on the output of Block 208), then process flow 200 may proceed by executing one or more steps or operations (e.g., at electric vehicle 102) to accept the power flow from charging station(s) 104a,b,c (Block 214). Process flow 200 may proceed by executing one or more steps or operations (e.g., at electric vehicle 102) for receiving power from the power flow (e.g., via an on-board charger) and charging at least one battery of electric vehicle 102 (Block 216).

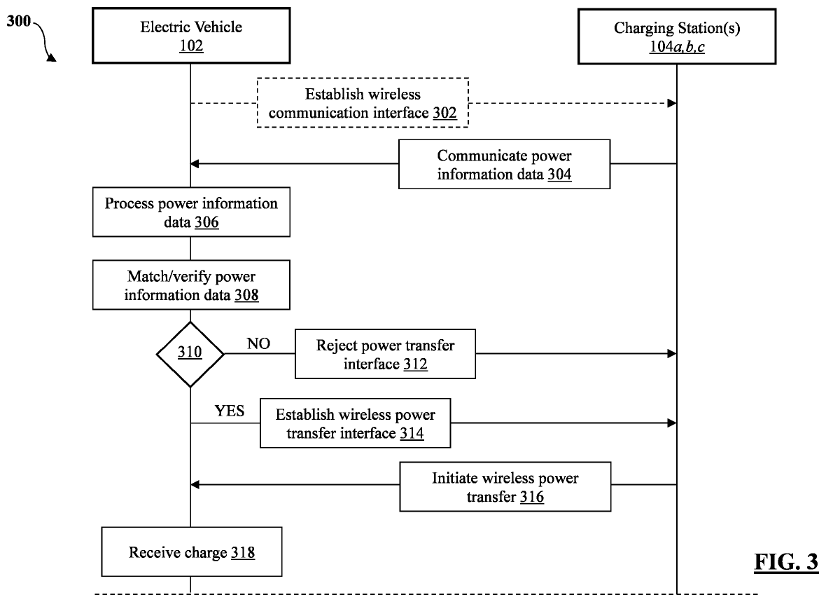

Referring now to FIG. 3, a functional block diagram of a process flow 300 for a subscription-based electric vehicle charging system and method is shown. In accordance with certain aspects of the present disclosure, process flow 300 comprises one or more routines and/or operations of system 100a of FIG. 1A and/or system 100b of FIG. 1B and/or system 100c of FIG. 1C. In accordance with certain aspects of the present disclosure, process flow 300 comprises one or more operations and/or data transfer protocols by and between electric vehicle 102 (e.g., as shown and described in FIGS. 1A-1C) and charging station(s) 104a,b,c (e.g., as shown and described in FIGS. 1A-1C). In accordance with certain aspects of the present disclosure, process flow 300 comprises one or more steps or operations for establishing a wireless communications interface between electric vehicle 102 and charging station(s) 104a,b,c (Block 302). The wireless communications interface may comprise a radio frequency signal or other electromagnetic signal. Process flow 300 may proceed by executing one or more steps or operations for communicating a first set of power flow information data from charging station(s) 104a,b,c to electric vehicle 102 (e.g., via the wireless communication interface) (Block 304). Process flow 300 may comprise one or more steps or operations (e.g., at electric vehicle 102) for processing the first set of power flow information data (Block 306) to match (or otherwise verify or validate) one or more attributes of the first set of power flow information data to a second set of power flow information data stored in local memory of electric vehicle 102 (or residing on a remote server communicably engaged with electric vehicle 102) (Block 308). In accordance with certain aspects of the present disclosure, process flow 300 may comprise one or more decision operations (Block 310) for verifying a subscription status for electric vehicle 102 based on the first set of power flow information data. In certain embodiments, Block 310 may comprise one or more steps or operations for determining whether the first set of power flow information data matches (or is otherwise compatible with or complementary to) the second set of power flow information data (e.g., according to an output of Block 308). If NO (i.e., the first set of power flow information data does not match or cannot be validated or authenticated based on the output of Block 308), then process flow 300 may proceed by executing one or more steps or operations (e.g., at electric vehicle 102) to reject a power transfer interface with charging station(s) 104a,b,c (Block 312). If YES (i.e., the first set of power flow information data matches or is otherwise validated or authenticated based on the output of Block 308), then process flow 300 may proceed by executing one or more steps or operations (e.g., at electric vehicle 102) to establish a power transfer interface with charging station(s) 104a,b,c (Block 314). In accordance with certain embodiments, the power transfer interface comprises a wireless power transfer interface. Process flow 300 may proceed by executing one or more steps or operations (e.g., at charging station(s) 104a,b,c) for initiating a wireless power transfer between charging station(s) 104a,b,c and electric vehicle 102 (Block 316). Process flow 300 may proceed by executing one or more steps or operations (e.g., at electric vehicle 102) for receiving power from the wireless power transfer (e.g., via an on-board charger of electric vehicle 102) to deliver a charge to at least one battery of electric vehicle 102 (Block 318).

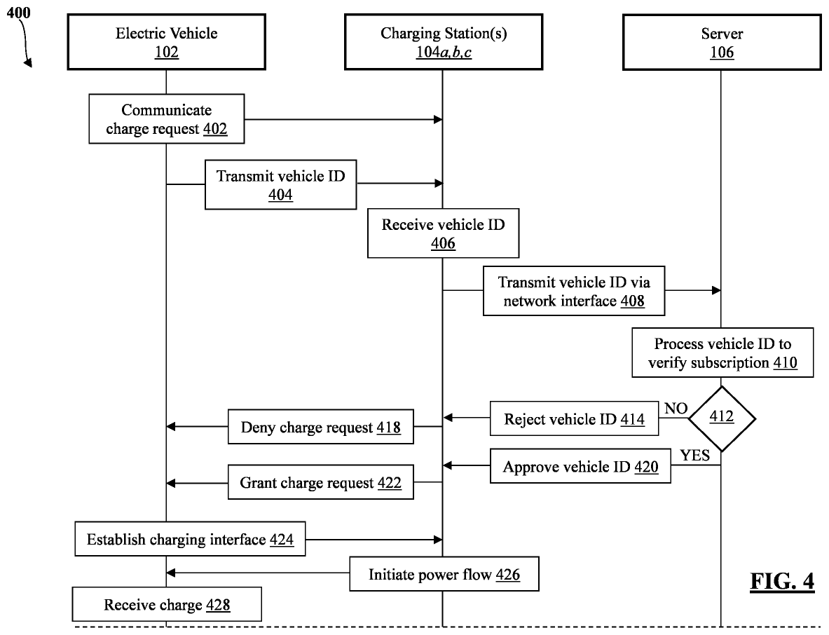

Referring now to FIG. 4, a functional block diagram of a process flow 400 for a subscription-based electric vehicle charging system and method is shown. In accordance with certain aspects of the present disclosure, process flow 400 comprises one or more routines and/or operations of system 100a of FIG. 1A and/or system 100b of FIG. 1B and/or system 100c of FIG. 1C. In accordance with certain aspects of the present disclosure, process flow 400 comprises one or more operations and/or data transfer protocols by and between electric vehicle 102 (e.g., as shown and described in FIGS. 1A-1C), charging station(s) 104a,b,c (e.g., as shown and described in FIGS. 1A-1C) and server 106 (e.g., as shown and described in FIGS. 1A-1C). In accordance with certain aspects of the present disclosure, process flow 400 comprises one or more steps or operations for communicating a charge request to at least one charging station(s) 104a,b,c (Block 402). The charge request may be formatted as a wireless communication between electric vehicle 102 and charging station(s) 104a,b,c or, alternatively, may be entered via a user interface of charging station(s) 104a,b,c. Process flow 400 may further comprise one or more steps or operations for transmitting a vehicle ID for electric vehicle 102 to charging station(s) 104a,b,c (Block 404). The vehicle ID may comprise a VIN number for electric vehicle 102 or other unique identification number associated with a subscription charging service. Process flow 400 may proceed by executing one or more steps or operations (e.g., via charging station(s) 104a,b,c) for receiving the vehicle ID at charging station(s) 104a,b,c (Block 406). Process flow 400 may proceed by executing one or more steps or operations (e.g., via charging station(s) 104a,b,c) for transmitting the vehicle ID (e.g., according to one or more communications protocols) from charging station(s) 104a,b,c to server 106 (Block 408). Server 106 may execute one or more steps or operations for processing the vehicle ID to verify a subscription status for vehicle 102 (Block 410).

In accordance with certain embodiments, Block 410 may comprise one or more steps or operations for verifying the subscription status for electric vehicle 102 according to one or more operations of a subscription charging application hosted on server 106. Process flow 400 may comprise one or more decision steps for approving or rejecting the vehicle ID based on an output of block 410 (Block 412). If NO, (i.e., electric vehicle 102 does not have a valid/active subscription), then process flow 400 proceeds by executing one or more steps or operations for communicating a rejection of the vehicle ID from server 106 to charging station(s) 104a,b,c (Block 414). In said instances, process flow 400 proceeds by executing one or more steps or operations for communicating a denial of the charge request from charging station(s) 104a,b,c to electric vehicle 102 (Block 418). If YES, (i.e., electric vehicle 102 has a valid/active subscription), then process flow 400 proceeds by executing one or more steps or operations for communicating an approval for the vehicle ID from server 106 to charging station(s) 104a,b,c (Block 420). In said instances, process flow 400 proceeds by executing one or more steps or operations for communicating an approval of the charge request from charging station(s) 104a,b,c to electric vehicle 102 (Block 422). In said instances, process flow 400 may proceed by executing one or more steps or operations for establishing a charging interface between electric vehicle 102 and charging station(s) 104a,b,c (Block 424). The charging interface may comprise a wired charging interface (e.g., via a charging cable) or a wireless charging interface (e.g., via a power source resonator and power capture resonator). Process flow 400 may proceed by executing one or more steps or operations for initiating a power flow from charging station(s) 104a,b,c to electric vehicle 102 (Block 426) and receiving a charge at a battery of electric vehicle 102 (Block 428).

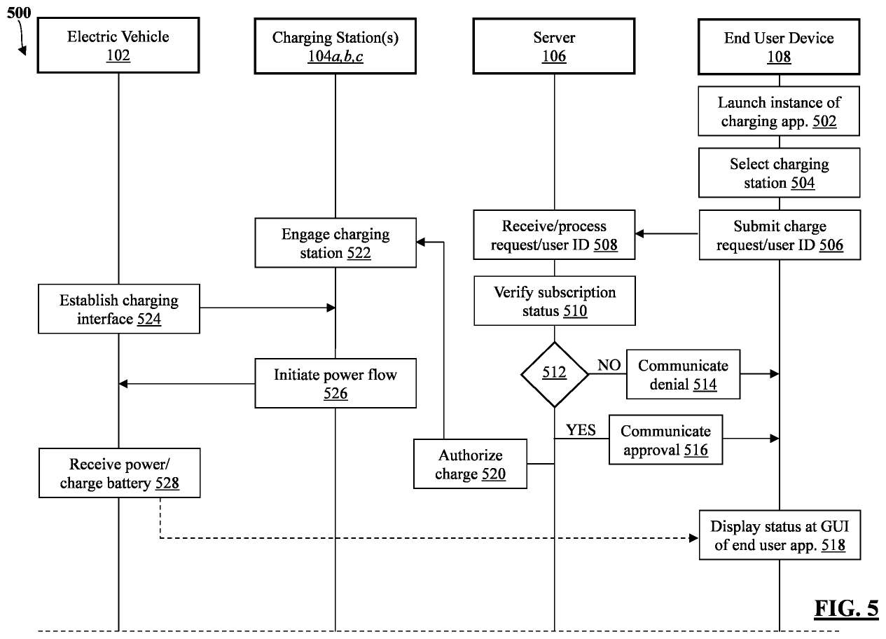

Referring now to FIG. 5, a functional block diagram of a process flow 500 for a subscription-based electric vehicle charging system and method is shown. In accordance with certain aspects of the present disclosure, process flow 500 comprises one or more routines and/or operations of system 100a of FIG. 1A and/or system 100b of FIG. 1B and/or system 100c of FIG. 1C. In accordance with certain aspects of the present disclosure, process flow 500 comprises one or more operations and/or data transfer protocols by and between electric vehicle 102 (e.g., as shown and described in FIGS. 1A-1C), charging station(s) 104a,b,c (e.g., as shown and described in FIGS. 1A-1C), server 106 (e.g., as shown and described in FIGS. 1A-1C) and end user device 108 (e.g., as shown and described in FIGS. 1A-1C). In accordance with certain aspects of the present disclosure, process flow 500 comprises one or more steps or operations for launching an end user instance of a subscription charging application at end user device 108 (Block 502). The end user instance of the subscription charging application may comprise a graphical user interface comprising one or more graphical elements configured to enable an end user to select a charging station, enter one or more account credentials associated with a subscription charging service, and enter payment information. Process flow 500 may proceed according to one or more steps or operations for receiving, at the graphical user interface, a user-generated selection for a charging station associated with the subscription charging service (Block 504) and submitting a charging request (including one or more user ID data and/or account credentials) to server 106 (Block 506). Process flow 500 may proceed according to one or more steps or operations for receiving the user-generated data (e.g., according to one or more communications protocols) at server 106 and processing the charging request and user ID data and/or account credentials (e.g., according to one or more data processing operations (Block 508). Process flow 500 may proceed by executing one or more steps or operations (e.g., via server 106) for verifying a subscription status for the selected charging station based on the user ID data and/or account credentials (Block 510). Process flow 500 may comprise one or more steps or operations for approving or denying the charge request based on an output of block 510 (Block 512). If NO (i.e., the end user does not have a valid subscription for the selected charging station based on the user ID data and/or account credentials), then process flow 500 proceeds by executing one or more steps or operations for communicating a denial of the charging request to end user device 108 (e.g., via the instance of the charging application) (Block 514). If YES (i.e., the end user has a valid subscription for the selected charging station based on the user ID data and/or account credentials), then process flow 500 proceeds by executing one or more steps or operations for communicating an approval of the charging request to end user device 108 (e.g., via the instance of the charging application) (Block 516).

Process flow 500 may comprise one or more steps or operations for displaying a status of the charging request to the end user via the graphical user interface of the end user application (Block 518). In response to block 516, process flow 500 may proceed by communicating an authorization of the charging request to charging station(s) 104a,b,c (Block 520). Process flow 500 may proceed by executing one or more steps or operations (e.g., at charging station(s) 104a,b,c) for engaging an operational mode of the selected charging station (Block 522). In certain embodiments, the selected charging station may display a confirmation of the charging request at a user interface of the charging station. Alternatively, or additionally, a status of the selected charging station may be displayed at the graphical user interface of the end user application. Process flow 500 may proceed by executing one or more steps or operations for establishing a charging interface between electric vehicle 102 and the selected charging station (Block 524). The charging interface may comprise a wired or wireless power transfer interface. Process flow 500 may proceed by executing one or more steps or operations for initiating a power flow from the selected charging station to electric vehicle 102 via the charging interface (Block 526). Process flow 500 may proceed by executing one or more steps or operations (e.g., at electric vehicle 102) for receiving the power flow from selected charging station and delivering a charge (e.g., via an on-board charger) to at least one battery of electric vehicle 102 (Block 528). In certain embodiments, a status of the battery charging may be displayed at the graphical user interface of the end user application.

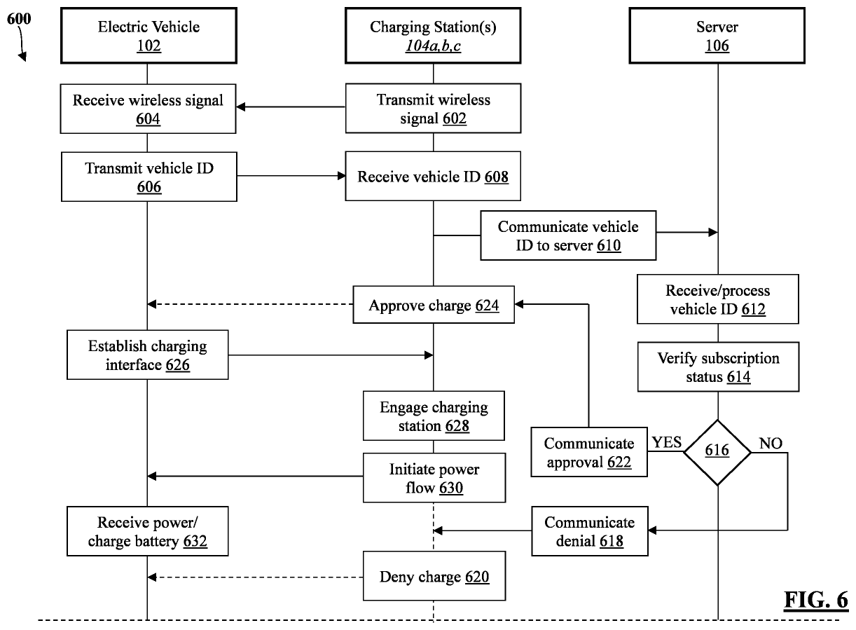

Referring now to FIG. 6, a functional block diagram of a process flow 600 for a subscription-based electric vehicle charging system and method is shown. In accordance with certain aspects of the present disclosure, process flow 600 comprises one or more routines and/or operations of system 100a of FIG. 1A and/or system 100b of FIG. 1B and/or system 100c of FIG. 1C. In accordance with certain aspects of the present disclosure, process flow 600 comprises one or more operations and/or data transfer protocols by and between electric vehicle 102 (e.g., as shown and described in FIGS. 1A-1C), charging station(s) 104a,b,c (e.g., as shown and described in FIGS. 1A-1C) and server 106 (e.g., as shown and described in FIGS. 1A-1C). In accordance with certain aspects of the present disclosure, process flow 600 comprises one or more steps or operations for transmitting a first wireless signal via charging station(s) 104a,b,c (Block 602). In certain embodiments, the first wireless signal may comprise power information data and/or other data for establishing a network communication protocol between electric vehicle 102 and charging station(s) 104a,b,c. Process flow 600 may proceed by executing one or more steps or operations at electric vehicle 102 for receiving the first wireless signal (Block 604) and transmitting a second wireless signal comprising a data packet including data to a vehicle ID for electric vehicle 102 (Block 606). Process flow 600 may proceed by executing one or more steps or operations at charging station(s) 104a,b,c for receiving the second wireless signal comprising the vehicle ID (Block 608) and communicating the vehicle ID to server 106 (e.g., according to at least one network communication protocol) (Block 610). Process flow 600 may proceed by executing one or more steps or operations at server 106 for receiving and processing the vehicle ID (e.g., according to at least one data processing framework) (Block 612) to verify a subscription status for a charging service of electric vehicle 102 (e.g., according to subscription data stored in an application database communicably engaged with server 106) (Block 614).

In accordance with certain embodiments, process flow 600 may proceed by executing one or more steps or operations at server 106 for determining the subscription status for the charging service according to an output of block 614 to approve or deny charging for electric vehicle 102 (Block 616). If NO (i.e., an output of block 614 indicates electric vehicle 102 does not have a valid subscription for the charging service), then process flow 600 may proceed by executing one or more steps or operations by server 106 to communicate a denial of charging for electric vehicle 102 (Block 618). In said instances, process flow 600 may comprise one or more steps or operations at charging station(s) 104a,b,c to deny a charge/power transfer interface between electric vehicle 102 and charging station(s) 104a,b,c (Block 620). In certain embodiments, block 620 may comprise one or more steps or operations for communicating the denial to electric vehicle 102. If YES (i.e., an output of block 614 indicates electric vehicle 102 has a valid subscription for the charging service), then process flow 600 may proceed by executing one or more steps or operations by server 106 to communicate an approval of charging for electric vehicle 102 (Block 622). In said instances, process flow 600 may comprise one or more steps or operations at charging station(s) 104a,b,c to approve a charge/power transfer interface between electric vehicle 102 and charging station(s) 104a,b,c (Block 624). In certain embodiments, block 624 may comprise one or more steps or operations for communicating the approval to electric vehicle 102. Process flow 600 may proceed by executing one or more steps or operations for establishing a charging interface (i.e., power transfer interface) between electric vehicle 102 and charging station(s) 104a,b,c (Block 626). The charging interface may comprise a wireline interface (e.g., charging cable) or a wireless power transfer interface. Process flow 600 may proceed by executing one or more steps or operations at charging station(s) 104a,b,c for engaging the selected charging station (Block 628) and initiating a power flow to electric vehicle 102 via the charging interface (Block 630). Process flow 600 may proceed by executing one or more steps or operations at electric vehicle 102 for receiving power from the power flow (e.g., via an on-board charger) and delivering a charge to a battery of electric vehicle 102 (Block 632).

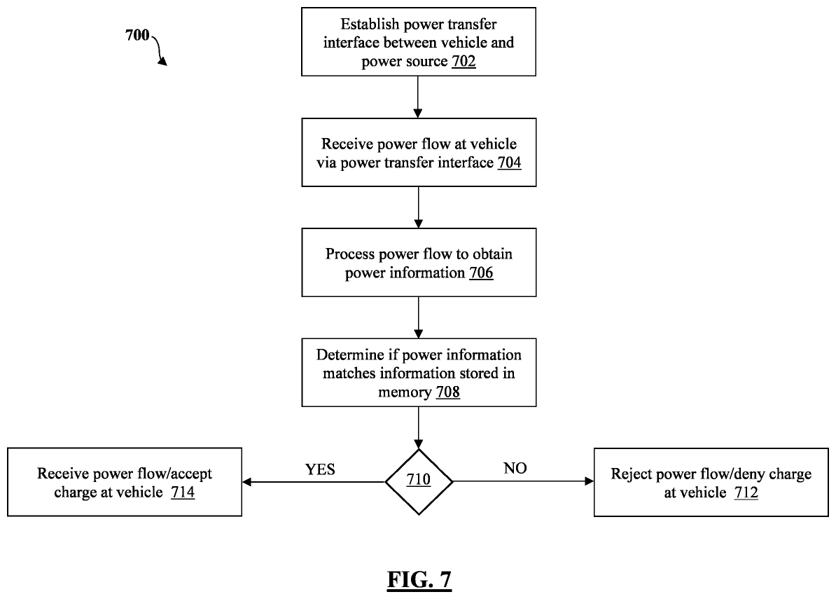

Referring now to FIG. 7, a process flow diagram of a subscription-based electric vehicle charging method 700 is shown. In accordance with certain aspects of the present disclosure, method 700 may be embodied as one or more routines and/or operations of system 100a of FIG. 1A and/or system 100b of FIG. 1B and/or system 100c of FIG. 1C. In accordance with certain aspects of the present disclosure, method 700 may comprise one or more steps or operations for establishing a power transfer interface between a vehicle and a power source (Step 702). In certain embodiments, the vehicle may comprise electric vehicle 102, as shown in FIGS. 1A-1C, and the power source may comprise charging station(s) 104a,b,c, as shown in FIGS. 1A-1C. In certain embodiments, the power transfer interface may comprise a wireless or a wireline power transfer interface. Method 700 may proceed by executing one or more steps or operations for receiving a power flow from the power source at the vehicle via the power transfer interface (Step 704). In accordance with certain aspects of the present disclosure, the power flow comprises a first set of power information data encoded or otherwise embodied therein. Method 700 may proceed by executing one or more steps or operations for processing the power flow to obtain the first set of power information data therefrom (Step 706). Method 700 may proceed by executing one or more steps or operations for determining whether the first set of power information data matches a second set of power information data stored in memory (e.g., prior to establishing the power transfer interface) (Step 708). In accordance with certain aspects of the present disclosure, the second set of power information data comprises one or more credentials for verifying or authenticating a subscription status for the vehicle for a charging service associated with the power source. In certain embodiments, one or more steps or operations of step 708 may be executed via a mobile application associated with the charging service, wherein the mobile application is executing on an end user device. In accordance with certain aspects of the present disclosure, method 700 may proceed by executing at least one decision step 710 based on an output of step 708. If an output of decision step 710 is NO (i.e., the first set of power information data does not match the second set of power information data stored in memory/the subscription is not confirmed), then method 700 may proceed by executing one or more steps or operations for rejecting the power flow from the power transfer interface (e.g., via an on-board charger of electric vehicle 102) and denying a charge at a battery of electric vehicle 102 (Step 712). If an output of decision step 710 is YES (i.e., the first set of power information data matches the second set of power information data stored in memory/the subscription is confirmed), then method 700 may proceed by executing one or more steps or operations for accepting/receiving the power flow from the power transfer interface (e.g., via an on-board charger of electric vehicle 102) and delivering a charge to the battery of electric vehicle 102 (Step 714).

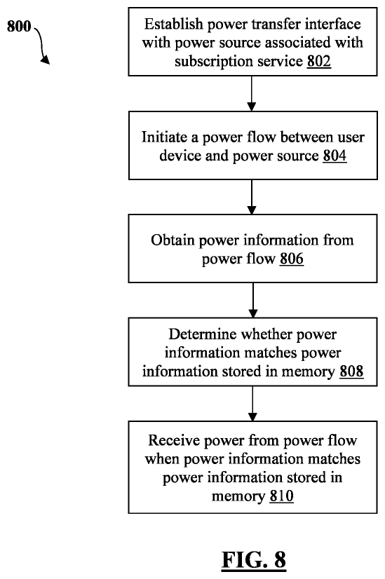

Referring now to FIG. 8, a process flow diagram of a subscription-based electric vehicle charging method 800 is shown. In accordance with certain aspects of the present disclosure, method 800 may be embodied as one or more routines and/or operations of system 100a of FIG. 1A and/or system 100b of FIG. 1B and/or system 100c of FIG. 1C. In accordance with certain aspects of the present disclosure, method 800 may comprise one or more steps or operations for establishing a power transfer interface associated with a subscription service between a user device and a power source (Step 802). In certain embodiments, the user device comprises an electric vehicle (e.g., electric vehicle 102 as shown in FIGS. 1A-1C). In said embodiments, the power source comprises a charging station configured to provide a flow of power to the electric vehicle (e.g., charging station(s) 104a,b,c, as shown in FIGS. 1A-1C). Method 800 may proceed by executing one or more steps or operations for initiating a flow of power between the user device and the power source via the power transfer interface (Step 804). Method 800 may proceed by executing one or more steps or operations for obtaining, from the power flow, a first set of power information (Step 806). The power information may include, for example, unique, one-of-a-kind digital and/or analog information (e.g., associated with one or more particular frequencies, frequency bands, bits, bytes, symbols, phases, polarizations, waveforms, modulations techniques, pulses, duty cycles, etc.) that enable the power flow to be identified and/or distinguished from other power flows with different power information or no power information. Method 800 may comprise one or more steps or operations for determining whether the first set of power information matches a second set of power information stored in memory (Step 808). The second set of power information may comprise one or more credentials associated with a subscription service for the power source. In accordance with certain aspects of the present disclosure, method 800 may proceed by receiving power from the power flow when the first set of power information matches the second set of power information stored in memory (Step 810). In certain embodiments, step 810 may comprise one or more steps or operations for providing a charge to at least one battery of the user device.

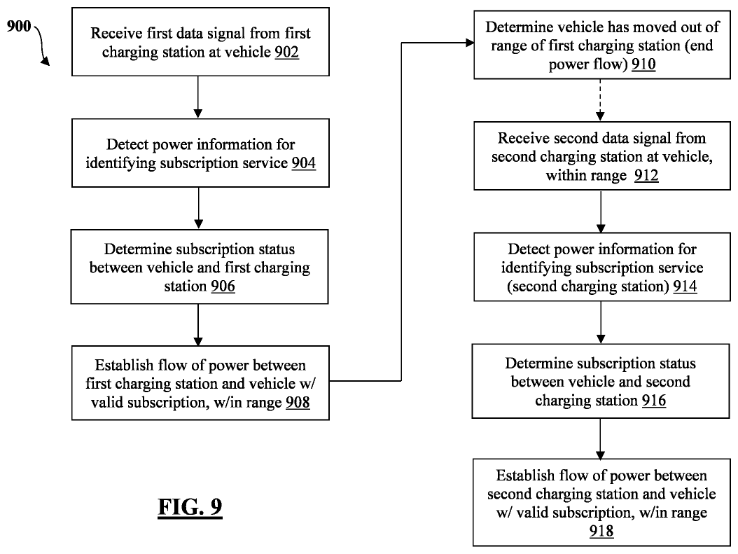

Referring now to FIG. 9, a process flow diagram of a subscription-based electric vehicle charging method 900 is shown. In accordance with certain aspects of the present disclosure, method 900 may be embodied as one or more routines and/or operations of system 100a of FIG. 1A and/or system 100b of FIG. 1B and/or system 100c of FIG. 1C. In accordance with certain aspects of the present disclosure, method 900 may comprise one or more steps or operations for receiving a first data signal from a first charging station at a vehicle, wherein the vehicle has moved within a transmission range of the first charging station (Step 902). In certain embodiments, the vehicle is in motion and is located at a first distance from the first charging station. In certain embodiments, the first distance is less than a threshold distance from the first charging station, beyond which a signal strength of the first data signal that is less than what can be processed by a receiver of the vehicle. Method 900 may proceed by executing one or more steps or operations for detecting a first set of power information from the first data signal, wherein the first set of power information comprises data for identifying a subscription service associated with the first charging station (Step 904). Method 900 may proceed by executing one or more steps or operations for processing the first set of power information, wherein the first set of power information comprises data for determining a subscription status between the vehicle and the first charging station (Step 906). In certain embodiments, step 906 comprises one or more steps or operations for comparing the first set of power information to a second set of power information stored in memory. The second set of power information may comprise one or more credentials for verifying the subscription service associated with the first charging station. Method 900 may proceed by executing one or more steps or operations for establishing a flow of power between the vehicle and the first charging station in response to successfully verifying the subscription status between the vehicle and the first charging station (Step 908). In accordance with certain aspects of the present disclosure, the flow of power comprises a wireless power transfer. In said embodiments, the flow of power between the vehicle and the first charging station is delivered to the vehicle when the vehicle is located within a specified range of the first charging station (i.e., inside a threshold distance). In certain embodiments, the flow of power is delivered wirelessly to the vehicle while the vehicle is in motion and located within the specified range of the first charging station (i.e., inside the threshold distance).

In accordance with certain aspects of the present disclosure, method 900 may proceed by executing one or more steps or operations for determining when the vehicle has moved outside of the specified range of the first charging station (Step 910). Step 910 may comprise one or more steps for determining a position of the vehicle according to the first data signal. In certain embodiments, step 910 may comprise one or more steps for determining a position of the vehicle according to GPS tracking data for the vehicle. In accordance with certain embodiments, step 910 comprises one or more steps or operations for discontinuing the flow of power by the first charging station in response to determining that the vehicle has moved outside of the specified range of the first charging station. Method 900 may proceed by executing one or more steps or operations for receiving a second data signal from a second charging station, wherein the vehicle has moved within a transmission range of the second charging station (Step 912). In certain embodiments, the vehicle is in motion and is located at a first distance from the second charging station (e.g., comprising a second distance from the first charging station). Method 900 may proceed by executing one or more steps or operations for detecting a third set of power information from the second data signal, wherein the third set of power information comprises data for identifying a subscription service associated with the second charging station (Step 914). Method 900 may proceed by executing one or more steps or operations for processing the third set of power information, wherein the third set of power information comprises data for determining a subscription status between the vehicle and the second charging station (Step 916). In certain embodiments, step 916 comprises one or more steps or operations for comparing the third set of power information to the second set of power information stored in memory, wherein the second set of power information comprises the one or more credentials for verifying the subscription service associated with the second charging station. Method 900 may proceed by executing one or more steps or operations for establishing a flow of power between the vehicle and the second charging station in response to successfully verifying the subscription status between the vehicle and the first charging station (Step 918). In accordance with certain aspects of the present disclosure, the flow of power comprises a wireless power transfer. In said embodiments, the flow of power between the vehicle and the second charging station is delivered to the vehicle when the vehicle is located within a specified range of the second charging station (i.e., inside a threshold distance). In certain embodiments, the flow of power is delivered wirelessly to the vehicle while the vehicle is in motion and located within the specified range of the second charging station (i.e., inside the threshold distance).

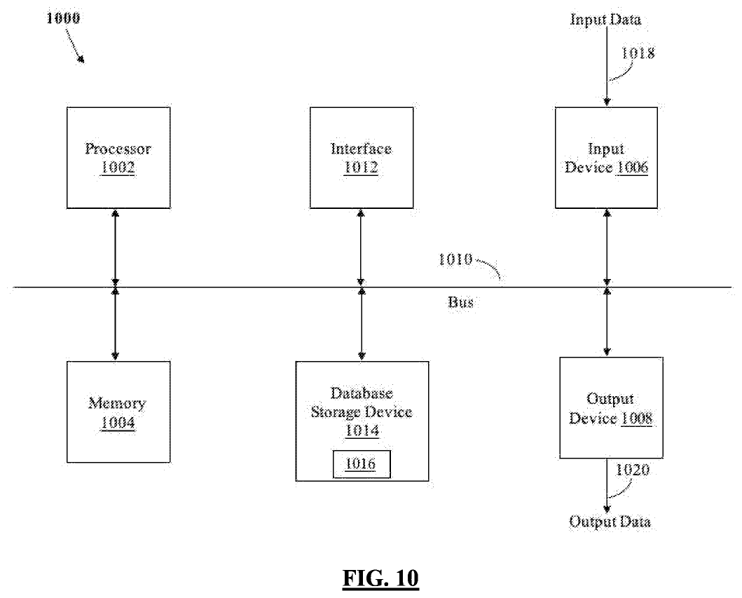

Referring now to FIG. 10, a processor-implemented computing system through which one or more aspects of the present disclosure may be implemented is shown. According to an embodiment, a computing system environment 1000 may generally comprise at least one processor 1002, or processing unit or plurality of processors, memory 1004, at least one input device 1006 and at least one output device 1008, coupled together via a bus or group of buses 1010. In certain embodiments, input device 1006 and output device 1008 could be the same device. An interface 1012 can also be provided for coupling the computing system environment 1000 to one or more peripheral devices, for example interface 1012 could be a PCI card or PC card. At least one storage device 1014 which houses at least one database 1016 can also be provided. The memory 1004 can be any form of memory device, for example, volatile or non-volatile memory, solid state storage devices, magnetic devices, etc. The processor 1002 could comprise more than one distinct processing device, for example to handle different functions within the computing system environment 1000. Input device 1006 receives input data 1018 and can comprise, for example, a keyboard, a pointer device such as a pen-like device or a mouse, audio receiving device for voice-controlled activation such as a microphone, data receiver or antenna such as a modem or wireless data adaptor, data acquisition card, etc. Input data 1018 could come from different sources, for example keyboard instructions in conjunction with data received via a network. Output device 1008 produces or generates output data 1020 and can comprise, for example, a display device or monitor in which case output data 1020 is visual, a printer in which case output data 1020 is printed, a port for example a USB port, a peripheral component adaptor, a data transmitter or antenna such as a modem or wireless network adaptor, etc. Output data 1020 could be distinct and derived from different output devices, for example a visual display on a monitor in conjunction with data transmitted to a network. A user could view data output, or an interpretation of the data output, on, for example, a monitor or using a printer. The storage device 1014 can be any form of data or information storage means, for example, volatile or non-volatile memory, solid state storage devices, magnetic devices, etc.

In use, the processing system 1000 is adapted to allow data or information to be stored in and/or retrieved from, via wired or wireless communication means, at least one database 1016. The interface 1012 may allow wired and/or wireless communication between the processing unit 1002 and peripheral components that may serve a specialized purpose. In general, the processor 1002 can receive instructions as input data 1018 via input device 1006 and can display processed results or other output to a user by utilizing output device 1008. More than one input device 1006 and/or output device 1008 can be provided. It should be appreciated that the computing system environment 1000 may be any form of terminal, server, specialized hardware, or the like.

It is to be appreciated that the computing system environment 1000 may be a part of a networked communications system. Computing system environment 1000 could connect to a network, for example the Internet or a WAN. Input data 1018 and output data 1020 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 1000 illustrated in FIG. 10 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 10 include a local area network (LAN) and a wide area network (WAN) but may also include other networks such as a personal area network (PAN). Such networking environments are commonplace in offices, enterprise-wide computer networks, intranets, and the Internet. For instance, when used in a LAN networking environment, the computing system environment 1000 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 1000, or portions thereof, may be stored in a remote memory storage device. It is to be appreciated that the illustrated network connections of FIG. 10 are exemplary and other means of establishing a communications link between multiple computers may be used.

FIG. 10 is intended to provide a brief, general description of an illustrative and/or suitable exemplary environment in which embodiments of the below described present invention may be implemented. FIG. 10 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the preceding description, certain embodiments may have been described with reference to acts and symbolic representations of operations that are performed by one or more computing devices, such as the computing system environment 1000 of FIG. 10. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random-access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general-purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions (i.e., computer-executable instructions) may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s). Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The computer-executable program code may also be loaded onto a computer or other programmable data processing apparatus to cause a series of operational phases to be performed on the computer or other programmable apparatus to produce a computer-implemented process such that the code portions which execute on the computer or other programmable apparatus provide phases for implementing the functions/acts specified in the flowchart and/or block diagram block(s). Alternatively, computer program implemented phases or acts may be combined with operator or human implemented phases or acts in order to carry out an embodiment of the invention.

As the phrases are used herein, a processor may be “operable to” or “configured to” perform a certain function in a variety of ways, including, for example, by having one or more general-purpose circuits perform the function by executing particular computer-executable program code embodied in computer-readable medium, and/or by having one or more application-specific circuits perform the function.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor but may be distributed in a modular fashion amongst a number of different computers or processors to implement various aspects of the present technology.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” As used herein, the terms “right,” “left,” “top,” “bottom,” “upper,” “lower,” “inner” and “outer” designate directions in the drawings to which reference is made.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention. Therefore, it will be apparent to those skilled in the art that various modifications and variations can be made to the disclosed embodiments without departing from the scope or spirit of the invention. In view of the foregoing, it is intended that the invention covers modifications and variations of this disclosure within the scope of the following claims and their equivalents.

What is claimed is:

1. An electric vehicle charging method comprising:
establishing a power transfer interface between a power source and an electric vehicle;
receiving, via the power transfer interface, a first flow of power from the power source at the electric vehicle;
processing, with an on-board processing unit of the electric vehicle, the first flow of power to determine a first set of power information data from the first flow of power;
processing, with the on-board processing unit of the electric vehicle, the first set of power information data to determine whether the first set of power information data is associated with an authorized power source for at least one charging subscription service for the electric vehicle; and
receiving, with an on-board charger of the electric vehicle, the first flow of power in response to determining that the first set of power information data is associated with the authorized power source for the at least one charging subscription service for the electric vehicle,
wherein the on-board charger of the electric vehicle is configured to charge a battery of the electric vehicle via the first flow of power.

2. The electric vehicle charging method of claim 1 further comprising rejecting, with the on-board charger of the electric vehicle, the first flow of power in response to determining that the first set of power information data is not associated with the authorized power source for the at least one charging subscription service for the electric vehicle.

3. The electric vehicle charging method of claim 1 wherein processing the first set of power information data comprises comparing the first set of power information data to at least one second set of power information data, wherein the second set of power information data is stored in an on-board memory device of the electric vehicle.

4. The electric vehicle charging method of claim 1 wherein the power transfer interface comprises a wireless power transfer interface.

5. The electric vehicle charging method of claim 1 further comprising communicating, with an on-board communications module of the electric vehicle, subscription identification data for the at least one charging subscription service for the electric vehicle to at least one remote server.

6. The electric vehicle charging method of claim 5 wherein the at least one remote server is configured to process the subscription identification data to determine a subscription status for the electric vehicle or at least one user of the electric vehicle.

7. The electric vehicle charging method of claim 6 further comprising communicating, with the at least one remote server via a network communications interface, the subscription status for the electric vehicle or at least one user of the electric vehicle to the on-board communications module of the electric vehicle.

8. An electric vehicle charging method comprising:
receiving, via a communications module of an electric vehicle, a first wireless signal from a first electric vehicle charging station,
wherein the first electric vehicle charging station is associated with a charging subscription service;
processing, via an on-board processor of the electric vehicle, the first wireless signal to determine a first set of data associated with the first electric vehicle charging station,
wherein the first set of data is configured to identify one or more attributes of the first electric vehicle charging station;
processing, via the on-board processor of the electric vehicle, the first set of data associated with the first electric vehicle charging station to determine a subscription status for the charging subscription service between the first electric vehicle charging station and the electric vehicle;
initiating, via a wireless power transfer interface, a first flow of power between the first electric vehicle charging station and the electric vehicle in response to determining a valid subscription status for the charging subscription service between the first electric vehicle charging station and the electric vehicle; and
receiving, with an on-board charger of the electric vehicle, the first flow of power from the first electric vehicle charging station,
wherein the on-board charger of the electric vehicle is configured to charge a battery of the electric vehicle via the first flow of power.

9. The electric vehicle charging method of claim 8 further comprising determining, via the on-board processor of the electric vehicle, a first distance between the first electric vehicle charging station and the electric vehicle, wherein the first distance comprises a range of the wireless power transfer interface between the first electric vehicle charging station and the electric vehicle.

10. The electric vehicle charging method of claim 9 further comprising discontinuing the first flow of power between the first electric vehicle charging station and the electric vehicle wherein the first distance is greater than a specified threshold.

11. The electric vehicle charging method of claim 10 further comprising receiving, via the communications module of the electric vehicle, a second wireless signal from a second electric vehicle charging station, wherein the second electric vehicle charging station is located at a different location from the first electric vehicle charging station.

12. The electric vehicle charging method of claim 11 further comprising processing, via the on-board processor of the electric vehicle, the second wireless signal to determine a second distance between the second electric vehicle charging station and the electric vehicle.

13. The electric vehicle charging method of claim 12 further comprising establishing a second wireless power transfer interface between the second electric vehicle charging station and the electric vehicle.

14. The electric vehicle charging method of claim 13 further comprising initiating, via the second wireless power transfer interface, a second flow of power between the second electric vehicle charging station and the electric vehicle.

15. A method comprising:
receiving, by a user device, a power flow from a charge source associated with a subscription service;
obtaining, by the user device, a first power information from the power flow;
determining, by the user device, whether the first power information matches a second power information stored in a memory device of the user device,
wherein the second power information is associated with the subscription service,
wherein the second power information was stored in the memory device of the user device prior to receiving the power flow; and
receiving, at a charging interface of the user device, a first power transfer from the power flow in response to determining that the first power information matches the second power information.

16. The method of claim 15 wherein the user device comprises an electric vehicle.

17. The method of claim 15 further comprising rejecting, at the charging interface of the user device, the first power transfer from the power flow in response to determining that the first power information does not match the second power information.

18. The method of claim 15 further comprising establishing a power transfer interface between the charge source and the user device.

19. The method of claim 18 wherein the power transfer interface comprises a wireless power transfer interface.

20. The method of claim 18 wherein establishing the power transfer interface comprises establishing an interface between a charging cable between the charge source and the user device.
